(19) United States
(12) Patent Application Publication
(10) Pub. No.: US 2006/0260995 A1
(43) Pub. Date: Nov. 23, 2006

(54) Filtered flow-through fitting

(76) Inventors: Doug McCormick, Cookeville, TN (US); Terry Shults, Cookeville, TN (US)

Correspondence Address: KUNZLER & ASSOCIATES, 8 EAST BROADWAY, SUITE 600, SALT LAKE CITY, UT, 84111, US

(21) Appl. No.: 11/135,089

(22) Filed: May 23, 2005

(51) Int. Cl. B01D 35/02; B01D 35/027

(52) U.S. Cl. 210/232

(57) ABSTRACT

A filtered flow-through fitting with an associated system and method are disclosed. The filtered flow-through fitting may include a fitting having a first opening and a second opening connected in fluid communication, a securing mechanism for securing the fitting within a cavity, and a filter extending outwardly from the first opening. The filtered flow-through fitting and associated system and method provide the benefits of allowing an engine component to be quickly and easily replaced, while providing additional protection to the engine's fluid systems by providing an additional layer of particulate matter filtration.

### BACKGROUND OF THE INVENTION

1. Field of the Invention

This invention relates to flow-through fittings for fluid systems and more particularly relates to filtered flow-through fittings.

2. Description of the Related Art

Fluid systems, especially in engine applications, are often highly susceptible to particle contamination. Particle contamination may clog or impede fluid flow within the system. In some instances, particle contamination may negatively affect system performance, increase toxin emissions, or even permanently damage engine components. Additionally, particle contamination may be difficult and expensive to repair. Often such repairs include flushing the fluid system, a complete replacement of the system fluid, or replacement of system components.

One common source of fluid system particle contamination is the replacement of engine components. For example, a fuel-water separator may collect particulate matter within the module. When the module is replaced, the particles are often stirred up and released into the entire fuel system. In some cases, the particles may clog fuel lines, fuel pumps, or fuel injection systems. Additionally, the particles can increase toxin emissions in the engine exhaust.

Engine components, such as fuel-water separators, oil filters, gas filters, and the like are often connected to the engine fluid systems by banjo bolts or other flow-through fittings. These flow-through fittings typically include two or more openings and a channel that connects the openings and allows fluid to flow through the fitting. These flow-through fittings often provide for egress between the engine component and the fluid system.

From the foregoing discussion, it should be apparent that a need exists for a filtered flow-through fitting. Beneficially, a filtered flow-through fitting would allow the engine component to be quickly and easily replaced, while providing additional protection to the engine's fluid systems by providing an additional layer of particulate matter filtration

### SUMMARY OF THE INVENTION

The present invention has been developed in response to the present state of the art, and in particular, in response to the problems and needs in the art that have not yet been fully solved by currently available flow-through fittings. Accordingly, the present invention has been developed to provide a filtered flow-through fitting that overcomes many or all of the above-discussed shortcomings in the art.

In one embodiment, the filtered flow-through fitting is provided with a fitting body having a first opening and a second opening connected in fluid communication, a securing mechanism connected with the fitting body for securing the fitting within a cavity, and a filter coupled to the fitting body and extending outwardly from the first opening. In one embodiment, the filtered flow-through fitting further comprises a passageway between the first opening and the second opening for fluid egress.

In one embodiment, the fitting further comprises a head coupled to the fitting body to facilitate securing the filtered flow-through fitting within the cavity by the securing mechanism. Additionally, the securing mechanism may further comprise threads on one of the fitting surfaces, the threads configured to secure to mating threads in the cavity.

In one embodiment, the filter further comprises a particle screen formed of a material selected from the group of materials consisting of wire mesh, synthetic mesh, natural fiber mesh, and corrugated fiber layers. Additionally, the filter may further comprise a structural support frame supporting the filter. In certain embodiments, the filter is further configured with a cylindrical cross-section, and has a diameter less than or equal to the diameter of the fitting, and wherein the filter is elongated with respect to the filter diameter, and has a length sufficient to extend into the interior of the cavity, and to be received by the cavity ahead of the fitting.

In another embodiment, the filtered flow-through fitting may include a fitting having a first opening and a second opening connected in fluid communication, a threaded exterior configured to mate with a connecting mechanism of an opening in a cavity and a filter extending outwardly from the first opening and received by the cavity.

In certain embodiments, the filter may include a particle screen formed of a material selected from the group of materials consisting of wire mesh, polymer, and corrugated fibers. Additionally, the filter may be fixedly coupled to the fitting. In one embodiment, the filter is configured to block the flow of a particle with an outer diameter greater than three hundred micrometers.

In further embodiments, the filtered flow-through fitting may include a banjo bolt having a first opening and a second opening connected in fluid communication, a treaded exterior for securing the fitting within an engine cavity configured with mated threading, and a screen fixedly coupled to the first opening, extending longitudinally from the first opening, and received by the engine cavity.

In one embodiment, the screen is further configured with a cylindrical cross-section, with a diameter less than or equal to the diameter of the banjo bolt, to be elongated with respect to the filter diameter, with a length sufficient to extend into the interior of the cavity, and to be received by the engine cavity ahead of the fitting. In a further embodiment, the filter may include a fixedly attached structural support frame. Additionally, the screen may comprise a material selected from a group of material consisting of woven wire mesh and extruded synthetic mesh.

Alternatively, the filtered flow-through may include a fitting body having a first opening and a second opening connected in fluid communication, a securing mechanism connected with the fitting body for securing the fitting within a cavity, and a filter coupled to the fitting body and extending inwardly from the first opening.

A system of the present invention is also presented for filtering fluid. In one embodiment, the system includes a cavity within an engine component configured to receive a filtered flow-through fitting and pass fluid through the filtered flow-through fitting, a filtered flow-through fitting having a first opening and a second opening connected in fluid communication, a threaded exterior for securing the fitting within the cavity, and a filter extending outwardly from the first opening and received by the cavity, and an engine fluid system coupled to the engine component by the filtered flow-through fitting.

In one embodiment, the engine fluid system is coupled to the flow-through fitting by a fluid conduit. The fluid conduit may be selected from a group of conduit consisting of hose, pipe, and tube. In certain embodiments, the fluid system is selected from a group of fluid systems comprising an engine coolant system, an engine oil system, a fuel system, an engine exhaust system, a break fluid system, a transmission fluid system, a clutch fluid system, and a washer fluid system. In various embodiments, the system may additionally include features or components of the filtered flow-through fitting as described in the paragraphs above.

A method of the present invention is also presented for providing filtered fluid coupling between an engine component and an engine fluid system using a filtered flow-through fitting. The method in the disclosed embodiments substantially includes the steps necessary to carry out the functions presented above with respect to the operation of the described apparatus and system. In one embodiment, the method includes providing a fitting having a first opening and a second opening connected in fluid communication, providing a securing mechanism for securing the fitting within a cavity, providing a filter extending outwardly from the first opening, coupling the first opening of the flow-through fitting to an engine component, and coupling the second opening of the flow-through fitting to an engine fluid system.

The method also may include providing a structural support frame to support the filter structure. Additionally, the method may also include providing a fluid conduit comprising a circular enclosure for coupling the engine fluid system to the filtered flow-through fitting. In certain embodiments, the method includes providing engine fluid filtration for an engine fluid selected from a group of fluids consisting of engine coolant, engine oil, fuel, break-fluid, transmission fluid, clutch fluid, and engine exhaust. In addition, the method may include blocking the flow of a particle with an outer diameter grater than three hundred micrometers

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize that the invention may be practiced without one or more of the specific features or advantages of a particular embodiment. In other instances, additional features and advantages may be recognized in certain embodiments that may not be present in all embodiments of the invention.

These features and advantages of the present invention will become more fully apparent from the following description and appended claims, or may be learned by the practice of the invention as set forth hereinafter.

### BRIEF DESCRIPTION OF THE DRAWINGS

In order that the advantages of the invention will be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1A is a perspective phantom view illustrating one embodiment of a filtered flow-through fitting;

FIG. 1B is a perspective view illustrating one embodiment of a filtered flow-through fitting, wherein the filter extends through the fitting body;

FIG. 2 is a perspective view illustrating one embodiment of a filtered banjo bolt;

FIG. 3 is a perspective view illustrating one embodiment of a filtered flow-through fitting incorporating a polymer filter and structural support on the filter;

FIG. 4 is a cross-sectional cutaway view illustrating one embodiment of a system for filtering fluid including a side view of the filtered flow-through fitting of FIG. 2; and

FIG. 5 is a schematic flow chart diagram illustrating one embodiment of a method for providing filtered fluid coupling between an engine component and an engine fluid system using a filtered flow-through fitting.

### DETAILED DESCRIPTION OF THE INVENTION

Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

Furthermore, the described features, structures, or characteristics of the invention may be combined in any suitable manner in one or more embodiments. In the following description, numerous specific details are provided, such as examples of filter material, securing mechanisms, and flow-through fittings to provide a thorough understanding of embodiments of the invention. One skilled in the relevant art will recognize, however, that the invention may be practiced without one or more of the specific details, or with other methods, components, materials, and so forth. In other instances, well-known structures, materials, or operations are not shown or described in detail to avoid obscuring aspects of the invention.

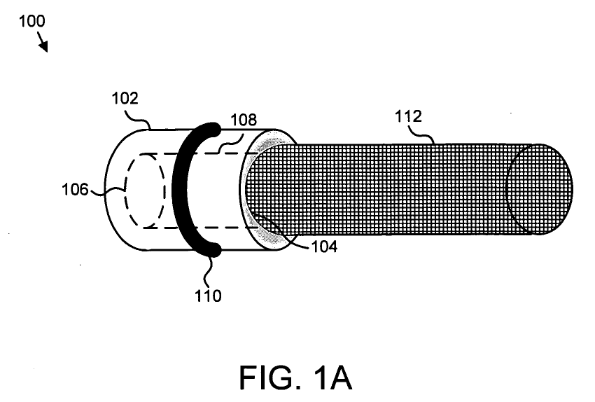

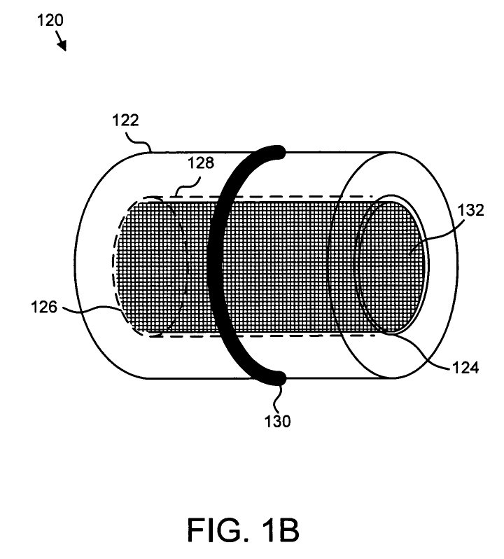

FIG. 1A depicts one embodiment of a filtered flow-through fitting 100. In the depicted embodiment, the filtered flow-through fitting 100 includes a fitting 102 having a first opening 104 and a second opening 106 connected in fluid communication by a channel 108. Additionally, the filtered flow-through fitting 100 is shown including a securing mechanism 110 and a filter 112.

In one embodiment, the filtered flow-through fitting 100 includes a fitting 102. As used herein, the term “fitting” includes a connecting, coupling, angled, or other like accessory used for fluid transfer, fluid routing, coupling, and the like. For example, the term fitting may be compatibly used in terms such as pipe fittings, conduit fittings, filter fittings, engine fittings, valve fittings, and the like.

In one embodiment, the fitting 102 is made of plastic. For example, the fitting 102 may be an injection molded plastic tubing connector. Alternatively, the fitting 102 is made of metal such as steel, copper, iron, aluminum, alloy, or the like. For example, the fitting 102 may be a stainless steel threaded bolt. In this example, the threaded bolt includes a first opening 104 and a second opening 106 connected in fluid communication by a channel 108. In such an example, the fitting 102 is configured for the flow-through of fluid. One example of such a flow-through fitting 102 is a banjo bolt used in hydraulic systems.

In one embodiment, the filtered flow-through fitting 100 includes a securing mechanism 110 for securing the fitting 102 within a cavity. As used herein, the term “cavity” refers to an unfilled space within a mass. For example, a cavity may include a port, an opening, a circular enclosure, a hole, an opening at the end of a hose or pipe, and the like. Specifically, the term cavity may refer to an opening in an engine component, hydraulic line, or the like configured to receive a fitting 102.

The securing mechanism 110 may include barbs on the outer surface of the fitting 102, treads, a clamp, a ridge, or other mechanism for securing the fitting 102 in a receiving cavity. In one embodiment, the securing mechanism 110 includes threads on one of the surfaces of the fitting 102, the threads configured to secure to mating threads in a receiving cavity. Alternatively, the securing mechanism includes precise physical dimensions on the outer surface of the fitting suitable for forced fit or friction fit securing of the fitting 102 within the cavity. As used herein, a securing mechanism 110 does not necessarily need to be integrally formed on the fitting. Conversely, the securing mechanism 110 may be a separate component of the fitting 102.

In one embodiment, the filtered flow-through fitting 100 includes a filter 112 extending outwardly from the first opening 104. Alternatively, the filter 112 may extend inwardly from the first opening 104, such that the filter structure is contained within the fitting body 102. In one embodiment, the filter 112 may be a particle screen formed of wire mesh, synthetic mesh, natural fiber mesh, or corrugated fiber layers. For example, the filter 112 may include a cylindrical screen formed of metal wire mesh. The wire mesh may be welded, soldered, or otherwise attached along the length of the cylindrical screen structure and at the end of the screen. Additionally, the filter 112 may be fixedly attached to the fitting 102. In such an example, the filter 112 may block the flow of a particle with an outer diameter greater than three hundred micrometers. Alternative embodiments including corrugated fiber layers and screens with a finer mesh may block the flow of particles with smaller outer diameters.

FIG. 1B illustrates an alternative embodiment of a filtered flow-through fitting 120, wherein a filter 132 extends through the fitting body 122. The fitting 120 includes a fitting body 122, and a first opening 124 and a second opening 126 connected in fluid communication by a channel 128. Additionally, the fitting 120 includes a securing mechanism 130 coupled to the fitting body 122 for securing the fitting within a cavity. In one embodiment, the described elements of the fitting 120 may be embodied in similar structure as those described with relation to FIG. 1A.

The filter 132 may be coupled to the first opening 124 and extend through the fitting body 122. In one embodiment, the filter 132 extends the full length of the channel 128. Alternatively, the filter 132 may extend partially into the interior of the channel 128. The filter 132 may include a screen with a hollow or vacant core. Alternatively, the filter 132 may include loosely packed filtration particles such as activated charcoal or the like, wherein the filtration particles are packed within the interior of the channel 128. The filter 132 may comprise one of the filter materials described with relation to the filter 112 of FIG. 1A.

In another embodiment, the filter 132 may extend partially into the interior of the channel 128 and extend outwardly from the first opening such that a portion of the filter 132 is contained within the fitting body 122 and a portion of the filter extends outwardly from the fitting body 122. In certain embodiments, the filter 132 may include a planar screen positioned within the channel 128 at a position at or between the first opening 124 and the second opening 126.

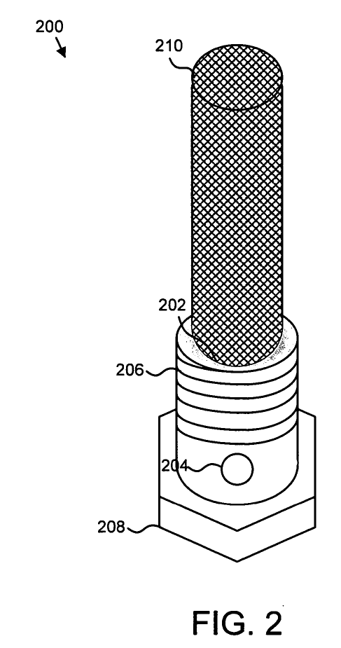

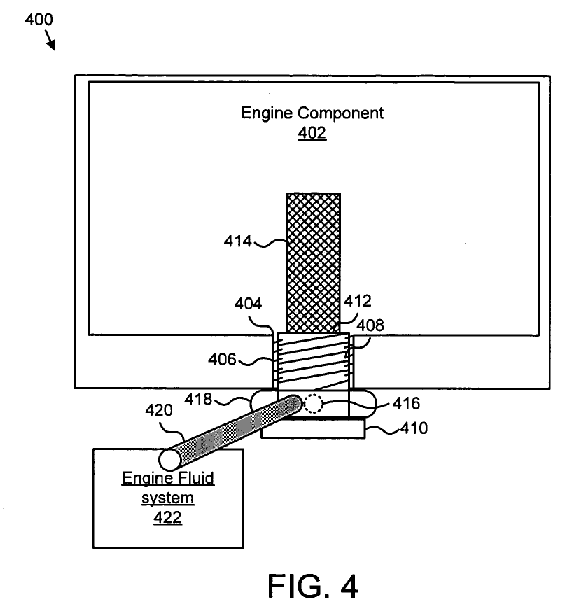

FIG. 2 illustrates one embodiment of a filtered banjo bolt 200 incorporating a threaded securing mechanism 206. In one embodiment, the threads 206 mate with a connecting mechanism of an opening in a cavity. Additionally, the filtered banjo bolt 200 may include a head 208 configured to facilitate securing the filtered banjo bolt 200 or other filtered flow-through fitting 100 by the securing mechanism 206. In certain embodiments, the second opening 204 may be positioned on the side of the banjo bolt to allow fluid to be transferred to a banjo collar coupled to the banjo bolt 200. A more detailed description of the banjo collar and the coupling between the banjo collar and the filtered banjo bolt 200 is given in the description of FIG. 4.

In one example of an implementation of the filtered banjo bolt 200, a fuel/water separator module may include a threaded fluid outlet port configured to receive a threaded banjo bolt. In such an example, the threaded banjo bolt may be replaced by a filtered banjo bolt 200 which is configured for fluid egress. In one embodiment, the threaded exterior 206 of the filtered banjo bolt 200 may mate with the threads on the fluid outlet port of the fuel/water separator module, and secure the filtered banjo bolt 200 within the fuel/water separator module. Alternative embodiments which include alternate filtered flow-through fittings 100 and different securing mechanisms 106 for securing the filtered flow-through fitting 100 in various openings or cavities may be implemented by one of ordinary skill in the art of fluid dynamics and fluid system design.

In one embodiment, the filter 210 extends outwardly from the first opening 202 and may be received by a cavity or opening. In certain embodiments, the filter 210 may extend longitudinally from the first opening 202 and may be received ahead of the fitting portion of the filtered banjo bolt 200 by an engine cavity. The filter 210 may be configured with a cylindrical cross-section, with a diameter less than or equal to the diameter of the body of the banjo bolt, to be elongated with respect to the filter diameter, and with a length sufficient to extend into the interior of the cavity.

Standard banjo bolts that do not include a filter 210 often suffer from clogging, restricted fluid flow, and contamination. The specific filter dimensions described above may be beneficial in reducing clogs and contamination while improving fluid flow rates. The filter 210 may have a cylindrical cross-section to provide a large surface area available for fluid transfer while allowing the filter 210 to pass through the threaded opening in the cavity ahead of the banjo bolt body. Allowing the filter 210 to extend within the cavity may significantly reduce clogging.

In certain embodiments, some characteristics of the filter 210 may be optimized to increase fluid flow rates and reduce clogging. For example, the hole size of the filter 210 may be optimized to improve flow rate, the length of screen extending within the cavity may be increased to reduce clogging, the screen material and thicknesses may be optimized to reduce surface tension, and the like.

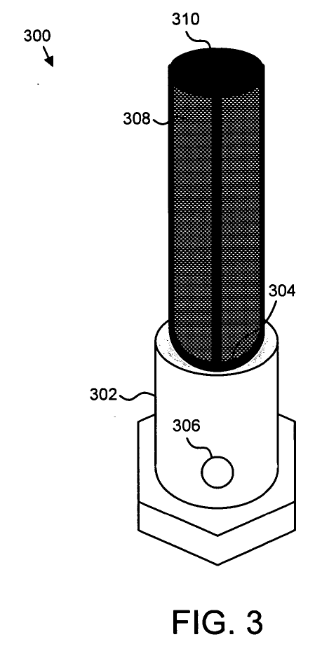

FIG. 3 illustrates one embodiment of a filtered flow-through fitting 300 incorporating a polymer filter 308 and a structural support frame 310. In one embodiment, the filtered flow-through fitting 300 may additionally include a first opening 304 and a second opening 306 connected in fluid communication, a threaded exterior for securing the fitting 302 within an engine cavity configured with mated threads, and in certain embodiments, the filter 308 comprises a screen. The screen 308 may be fixedly coupled to the first opening 304, and extend longitudinally from the first opening 304.

In one embodiment, the structural support frame 310 may be fixedly coupled to the screen. Alternatively, the structural support frame 310 may not be in physical contact with the screen 308, but provide structural protection. In another embodiment, the structural support frame 310 may also be fixedly coupled to the first opening 304 or to the fitting body 302. The structural support frame 310 may be fabricated from metal, polymer, or other material with suitable structural integrity. For example, the structural support frame 310 may include an injection molded polymer frame comprising an end portion and leg portions running the length of the screen 308. In one embodiment, the structural support frame 310 may be fused to the screen 308 using adhesive, ultrasonic polymer welding, or other suitable means.

In certain embodiments, the screen 308 may include a woven wire mesh or an extruded synthetic mesh. Alternatively, the screen 308 may include an injection molded, cast, or otherwise manufactured mesh. The mesh may include holes of variable sizes, wherein the hole sizes are dependent on the particle size that is to be blocked. Additionally, the mesh may include various hole shapes depending on the weave, strand overlay, or extrusion method used in manufacturing. Indeed, it is not required that the mesh be woven. The mesh may include strands of polymer or wire that are overlain and fused.

FIG. 4 illustrates one embodiment of a system 400 for filtering fluid. In one embodiment, the system 400 includes a cavity within an engine component 402 configured to receive a filtered flow-through fitting 410, and pass fluid through the filtered flow-through fitting 410. Additionally, the system may include a filtered flow-through fitting 410 having a first opening 412 and a second opening 416 connected in fluid communication. The fitting 410 may additionally include threads 408 for securing the fitting within the engine component 402 and a filter 414 that extends into the engine component 402. In one embodiment, the system 400 may also include an engine fluid system 422.

One example of a system 400 for filtering fluid includes the connection of a fuel/water separator to an engine fuel system. In one embodiment, the fuel/water separator may be the engine component 402, and the engine fuel system may be the engine fluid system 422. In such an example, the fuel/water separator may include an opening 404 configured with threads 406 for receiving a filtered banjo bolt 410. The threads 408 of the filtered banjo bolt 410 may mate with the threads 406 of the engine component opening 404. In one embodiment, the filter 414 is fixedly attached to the first opening 412 of the filtered banjo bolt 410. In this example, the engine component 402 may receive the filter 414 ahead of the body of the filtered banjo bolt 410.

In such an example, the engine fluid system 422 connects to the engine component 402 through a fluid conduit 420. In one embodiment, the fluid conduit 420 may additionally attach to a banjo collar 418. In this example, the banjo collar 418 may be inserted between the outer wall of the engine component 402 and the head of the filtered banjo bolt 410. The banjo collar 418 may include an assembly of gaskets, washers, or the like to seal the fluid within the collar 418 and conduit 420. In one embodiment, the conduit 420 may include a fuel line, hose, or the like. The banjo collar 418 may then receive the fluid that egresses from the second opening 416 of the filtered banjo bolt 410.

In this example, the fuel/water separator may be maintained, cleaned, replaced, or otherwise disturbed without contaminating the fuel system. Additionally, contaminants may collect around the base of the filter due to the force of gravity, but the upper portions of the filter may remain substantially unobstructed. Therefore, the fluid flow rates may be improved and clogging or congestion within the flow-through fitting 410 and conduit 420 may be reduced.

The schematic flow chart diagrams set forth below are generally set forth as logical flow chart diagrams. As such, the depicted order and labeled steps are indicative of one embodiment of the presented method. Other steps and methods may be conceived that are equivalent in function, logic, or effect to one or more steps, or portions thereof, of the illustrated method. Additionally, the format and symbols employed are provided to explain the logical steps of the method and are understood not to limit the scope of the method. Although various arrow types and line types may be employed in the flow chart diagrams, they are understood not to limit the scope of the corresponding method. Indeed, some arrows or other connectors may be used to indicate only the logical flow of the method. For instance, an arrow may indicate a waiting or monitoring period of unspecified duration between enumerated steps of the depicted method. Additionally, the order in which a particular method occurs may or may not strictly adhere to the order of the corresponding steps shown.

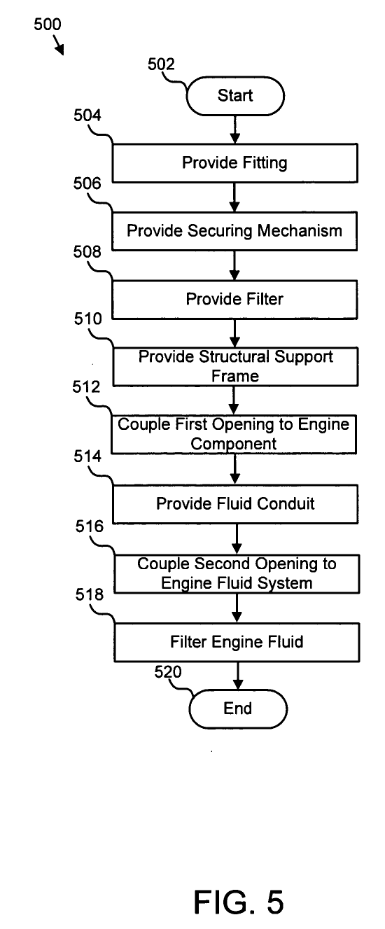

FIG. 5 illustrates one embodiment of a method 500 for providing filtered fluid coupling between an engine component 402 and an engine fluid system 422 using a filtered flow-through fitting 100. In one embodiment, the method 500 starts 502 by providing 504 a fitting 102. Additionally, the method 500 includes providing 506 a securing mechanism 110, and providing 508 a filter 112. In one embodiment, the method 500 may include providing 510a structural support frame 310. Then, the engine component 402 is coupled 512 to the first opening 104 of the filtered flow-through fitting 100.

In one embodiment, the method 500 may additionally include providing 514a fluid conduit 420. The engine fluid system 422 is then coupled 516 to the second opening 106 of the filtered flow-through fitting 100. In one embodiment, the coupling 516 may be provided by a banjo collar 418 and the fluid conduit 420. Then filtered flow-through fitting 100 filters 518 the engine fluid that flows between the engine component 402 and the engine fluid system 422 and the method 500 ends 520.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A filtered flow-through fitting comprising:
a fitting body having a first opening and a second opening connected in fluid communication;
a securing mechanism for securing the fitting within a cavity connected with the fitting; and
a filter coupled to the fitting body and extending outwardly from the first opening.

2. The filtered flow-through fitting of claim 1, further comprising a passageway between the first opening and the second opening for fluid egress.

3. The filtered flow-through fitting of claim 1, wherein the fitting further comprises a head coupled to the fitting body to facilitate securing the filtered flow-through fitting within the cavity by the securing mechanism.

4. The filtered flow-through fitting of claim 1, wherein the securing mechanism further comprises threads on one of the fitting surfaces, the threads configured to secure to mating threads in the cavity.

5. The filtered flow-through fitting of claim 1, wherein the filter further comprises a particle screen formed of a material selected from the group of materials consisting of wire mesh, synthetic mesh, natural fiber mesh, and corrugated fiber layers.

6. The filtered flow-through fitting of claim 1, further comprising a structural support frame supporting the filter.

7. The filtered flow-through fitting of claim 1, wherein the filter is further configured with a cylindrical cross-section, and has a diameter less than or equal to the diameter of the fitting, and wherein the filter is elongated with respect to the filter diameter, and has a length sufficient to extend into the interior of the cavity, and to be received by the cavity ahead of the fitting.

8. A filtered flow-through fitting comprising:
a fitting body having a first opening and a second opening connected in fluid communication;
threads on the exterior surface of the fitting body configured to mate with mating threads of an opening in a cavity; and
a filter coupled to the fitting body, extending outwardly from the first opening, and received by the cavity.

9. The filtered flow-through fitting of claim 8, wherein the filter further comprises a particle screen formed of a material selected from the group of materials consisting of wire mesh, polymer, and corrugated fibers.

10. The filtered flow-through fitting of claim 8, wherein the filter is fixedly coupled to the fitting.

11. The filtered flow-through fitting of claim 8, wherein the filter is further configured to block the flow of a particle with an outer diameter greater than three hundred micrometers.

12. A filtered flow-through fitting comprising:
a banjo bolt having a first opening and a second opening connected in fluid communication;
a threaded exterior on the banjo bolt for securing the fitting within an engine cavity configured with mated threading; and
a screen fixedly coupled to the first opening, extending longitudinally from the first opening, and received by the engine cavity.

13. The filtered flow-through fitting of claim 12, wherein the screen is further configured with a cylindrical cross-section, and has a diameter less than or equal to the diameter of the fitting, and wherein the filter is elongated with respect to the filter diameter, and has a length sufficient to extend into the interior of the cavity, and to be received by the cavity ahead of the fitting.

14. The filtered flow-through fitting of claim 12, further comprising a structural support frame fixedly attached to the screen.

15. The filtered flow-through fitting of claim 12, wherein the screen further comprises a material selected from the group of materials consisting of woven wire mesh and extruded synthetic mesh.

16. A filtered flow-through fitting comprising:
a fitting body having a first opening and a second opening connected in fluid communication;
a securing mechanism for securing the fitting within a cavity connected with the fitting; and
a filter coupled to the first opening and extending through at least a portion of the fitting body.

17. A system for filtering fluid, the system comprising:
a cavity within an engine component configured to receive a filtered flow-through fitting and pass fluid through the filtered flow-through fitting;
a filtered flow-through fitting having a first opening and a second opening connected in fluid communication, a threaded exterior for securing the fitting within the cavity, and a filter extending outwardly from the first opening and received by the cavity; and
an engine fluid system coupled to the engine component by the filtered flow-through fitting.

18. The system of claim 16, wherein the engine fluid system is coupled to the flow-through fitting by a fluid conduit.

19. The system of claim 17, wherein the fluid conduit is selected from the group of conduits consisting of hose, pipe, and tube.

20. The system of claim 16, wherein the engine fluid system is selected from the group of fluid systems comprising an engine coolant system, an engine oil system, a fuel system, an engine exhaust system, a break fluid system, a transmission fluid system, a clutch fluid system, and a washer fluid system.

21. The system of claim 16, wherein the filter is further configured to block the flow of a particle with an outer diameter greater than three hundred micrometers.

22. A method for providing filtered fluid coupling between an engine component and an engine fluid system using a filtered flow-through fitting, the method comprising:
providing a fitting having a first opening and a second opening connected in fluid communication;
providing a securing mechanism for securing the fitting within a cavity;
providing a filter extending outwardly from the first opening;
coupling the first opening of the flow-through fitting to an engine component; and
coupling the second opening of the flow-through fitting to an engine fluid system.

23. The method of claim 21, further comprising providing a structural support frame to support the filter structure.

24. The method of claim 21, further comprising providing a fluid conduit comprising a circular enclosure for coupling the engine fluid system to the filtered flow-through fitting.

25. The method of claim 21, further comprising providing engine fluid filtration for an engine fluid selected from a group of fluids consisting of engine coolant, engine oil, fuel, break fluid, transmission fluid, clutch fluid, washer fluid, and engine exhaust.

26. The method of claim 24, further comprising blocking the flow of a particle with an outer diameter greater than three hundred micrometers.
